(19) United States
(12) Patent Application Publication
(10) Pub. No.: US 2023/0031105 A1
(43) Pub. Date: Feb. 2, 2023

(54) REAGENT SLEEVE SYSTEM

(71) Applicant: Bio-Rad Laboratories, Inc., Hercules, CA (US)

(72) Inventors: James Barry, Irvine, CA (US); Vishal Mehra, Irvine, CA (US); Alireza Ebrahim, Irvine, CA (US)

(21) Appl. No.: 17/962,360

(22) Filed: Oct. 7, 2022

Related U.S. Application Data
(63) Continuation of application No. PCT/US2021/026265, filed on Apr. 7, 2021.
(60) Provisional application No. 63/007,286, filed on Apr. 8, 2020.

(51) Int. Cl. B01L 3/00; G01N 35/10

(52) U.S. Cl. CPC B01L 3/527; G01N 35/1002; G01N 2035/1086; B01L 2300/044; B01L 2300/0832

(57) ABSTRACT

A reagent sleeve system such as can be used with various analyzers using chemical phenomena, analyzers and methods of using the reagent sleeve system and analyzer are described. The reagent sleeve system can include a reagent sleeve; and a plurality of removable reagent reservoirs located within the reagent sleeve, wherein each of the plurality of removable reagent reservoirs comprises a respective peripheral wall, and first and second end walls, whereby each of the plurality of removable reagent reservoirs contains a reagent located therein, and the first end wall is pierceable by a reagent extractor, and the reagent sleeve comprises a peripheral wall that encompasses the plurality of removable reagent reservoirs and holds the plurality of reagent reservoirs for sequential use.

### CROSS-REFERENCES TO RELATED APPLICATIONS

This application is a continuation application of International Patent Application No. PCT/US2021/026265 entitled “REAGENT SLEEVE SYSTEM,” filed on Apr. 7, 2021, which claims priority to U.S. Provisional Application No. 63/007,286 entitled “REAGENT SLEEVE SYSTEM,” filed on Apr. 8, 2020, each of which are herein incorporated by reference in their entirety for all purposes.

### BACKGROUND

Analyzers, such as chemical analyzers, biological analyzers, DNA analyzers, immunoassay analyzers and other analyzers which utilize chemical phenomena in the course of performing their analysis require the delivery of one or more reagents. These reagents can expire based upon various criteria, and then can no longer be used for analyses relevant to the expiration.

It is desirable to reduce the amount of reagents which are subsequently disposed of and it is desirable to streamline the management of expiration dates and the transition of reagent containers.

### SUMMARY

In a first aspect disclosed herein a reagent sleeve system is provided. The reagent sleeve system comprises: a reagent sleeve; and a plurality of removable reagent reservoirs located within the reagent sleeve, wherein each of the plurality of removable reagent reservoirs comprises a respective peripheral wall, and first and second end walls, whereby each of the plurality of removable reagent reservoirs contains a reagent located therein, and the first end wall is pierceable by a reagent extractor, and the reagent sleeve comprises a peripheral wall that encompasses the plurality of removable reagent reservoirs and holds the plurality of reagent reservoirs for sequential use.

In a first embodiment of the first aspect, the second end wall of each of the plurality of removable reagent reservoirs is pierceable by a reagent extractor.

In a second embodiment of the first aspect, the plurality of reagent reservoirs is arranged end-to-end.

In a third embodiment of the first aspect, the second end wall of each of the plurality of removable reagent reservoirs is pierceable by a reagent extractor, the plurality of reagent reservoirs is arranged end-to-end and the reagent extractor can pass from pass through a first of the plurality of reagent reservoirs and into a second of the plurality of reagent reservoirs.

In a fourth embodiment of the first aspect, the peripheral wall each of the plurality of reagent reservoirs is cylindrical.

In a fifth embodiment of the first aspect, the first end wall of each of the plurality of reagent reservoirs comprises a pierceable film or sheet.

In a sixth embodiment of the first aspect, the reagent sleeve comprises a first opening through which each of the plurality of reagent reservoirs can pass.

In a seventh embodiment of the first aspect, the reagent sleeve comprises a second opening aligned with the pierceable end of a first of the plurality of reagent reservoirs, wherein the reagent extractor passes through the second opening when the reagent extractor pierces the pierceable end of the first reagent reservoir.

In an eighth embodiment of the first aspect, the reagent sleeve comprises a second opening aligned with the pierceable end of a first of the plurality of reagent reservoirs, wherein the reagent extractor passes through the second opening when the reagent extractor pierces the pierceable end of the first reagent reservoir and the second opening is covered with a pierceable cover.

In a ninth embodiment of the first aspect, the reagent sleeve is sized and configured to interface with an analyzer, a chemical analyzer or a clinical analyzer and the reagent extractor to pierce the first end wall of one of the plurality of reagent reservoirs.

In a tenth embodiment of the first aspect, each of the plurality of reagent reservoirs comprises a set of analysis reagents, with each of the set of analysis reagents having an expiration date set, and each of the plurality of reagent reservoirs has the same set of analysis reagents with the same expiration date sets.

In a second aspect, an analyzer, a chemical analyzer or a clinical analyzer is provided. The analyzer, chemical analyzer or clinical analyzer comprises: a reagent sleeve system port configured to receive a reagent sleeve system comprising: a reagent sleeve; and a plurality of removable reagent reservoirs located within the reagent sleeve, wherein each of the plurality of removable reagent reservoirs comprises a respective peripheral wall, and first and second end walls, whereby each of the plurality of removable reagent reservoirs contains a reagent located therein, and the first end wall is pierceable by a reagent extractor, and the reagent sleeve comprises a peripheral wall that encompasses the plurality of removable reagent reservoirs and holds the plurality of reagent reservoirs for sequential use; the reagent sleeve system being removably connected to the reagent sleeve port; the reagent extractor configured to deliver reagent from one of the plurality of reagent reservoirs for use in the analyzer, chemical analyzer or clinical analyzer.

In a third aspect, a method of using an analyzer, a chemical analyzer or a clinical analyzer is provided. The method comprises: piercing the first end wall of one of the plurality of reagent reservoirs with the reagent extractor of an analyzer, a chemical analyzer or a clinical analyzer that comprises: a reagent sleeve system port configured to receive a reagent sleeve system comprising: a reagent sleeve; and a plurality of removable reagent reservoirs located within the reagent sleeve, wherein each of the plurality of removable reagent reservoirs comprises a respective peripheral wall, and first and second end walls, whereby each of the plurality of removable reagent reservoirs contains a reagent located therein, and the first end wall is pierceable by a reagent extractor, and the reagent sleeve comprises a peripheral wall that encompasses the plurality of removable reagent reservoirs and holds the plurality of reagent reservoirs for sequential use; the reagent sleeve system being removably connected to the reagent sleeve port; the reagent extractor configured to deliver reagent from one of the plurality of reagent reservoirs for use in the analyzer, chemical analyzer or clinical analyzer to fluidly connect the one of the plurality of reagent reservoirs with the analyzer, chemical analyzer or clinical analyzer through the reagent extractor; and withdrawing reagent from the one of the plurality of reagent reservoirs through the reagent extractor.

In a first embodiment of the third aspect, the method further comprises: removing the one of the plurality of reagent reservoirs from the reagent sleeve prior to piercing the first end wall of the one of the plurality of reagent reservoirs with the reagent extractor.

In a second embodiment of the third aspect, the one of the plurality of reagent reservoirs is located at least partially within the reagent sleeve when the reagent is withdrawn from the one of the plurality of reagent reservoirs through the reagent extractor.

In a third embodiment of the third aspect, the method further comprises: withdrawing the reagent extractor from the one of the plurality of reagent reservoirs; then moving a second of the plurality of reagent reservoirs to a position where the first end wall of the second of the plurality of reagent reservoirs is pierceable by the reagent extractor; then piercing the first end wall of the second of the plurality of reagent reservoirs with the reagent extractor to fluidly connect the second of the plurality of reagent reservoirs with the analyzer, chemical analyzer or clinical analyzer through the reagent extractor; and withdrawing reagent from the second of the plurality of reagent reservoirs through the reagent extractor.

In a fourth embodiment of the third aspect, the method further comprises: moving the reagent extractor through the second end wall of the one of the plurality of removable reagent reservoirs; piercing the first end wall of the second of the plurality of reagent reservoirs with the reagent extractor; fluidly connecting the second of the plurality of reagent reservoirs with the analyzer, chemical analyzer or clinical analyzer through the reagent extractor; and withdrawing reagent from the second of the plurality of reagent reservoirs through the reagent extractor, wherein the second end wall the one of the plurality of removable reagent reservoirs is pierceable by a reagent extractor.

### BRIEF DESCRIPTION OF THE DRAWINGS

FIG. 1 is a diagram of an embodiment of a reagent sleeve system.

FIG. 2 is a diagram of an embodiment of a reagent sleeve system.

FIG. 3 is a diagram of an embodiment of a reagent sleeve system.

FIG. 4 is a diagram of an embodiment of a reagent reservoir.

FIG. 5 is a diagram of an embodiment of a reagent reservoir.

FIG. 6 is a diagram of an embodiment of a reagent sleeve.

FIG. 7 is a diagram of an embodiment of a reagent sleeve system positioned in an analyzer.

### DETAILED DESCRIPTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

Analyzers, such as chemical analyzers and clinical analyzers (including biological analyzers, DNA analyzers, immunoassay analyzers and other analyzers) which utilize chemical phenomena in the course of performing their analysis require the delivery of one or more reagents. Frequently these reagents have expiration dates where the use of the reagent beyond the expiration date can result in a questionable or inaccurate result. In some cases, the expiration date can be based upon the date when the reagent is prepared. In some cases, the expiration date can be based upon the date when a container of the reagent is opened. As chemical analyses have become more complicated and/or sophisticated, multiple reagents can be used within a single analysis and/or a single reagent can be used for a range of different analyses.

In some systems, a mixture of reagents can be provided in a single container. However, each individual reagent can have an expiration date that is dependent upon the reagent itself as well as the analysis it is being used for.

When an expiration date passes, the reagent can no longer be used under the circumstances of the expiration. Frequently, passage of one expiration date can result in disposal of the remainder of an entire container of reagent. In some circumstances, however, additional reagent(s) within the container could have been used for other analyses that are not affected by the passage of the one (or additional) expiration date(s). If this residual reagent is disposed of, the value of these additional reagents is lost.

While it can be desirable to utilize a smaller container of reagent, management of the expiration dates can be problematic, such as the need properly label containers can be impaired by the size of the container. Also, frequent transitioning between region containers can take time and also can result in lost material such as due to priming of the system or other startup/shutdown issues.

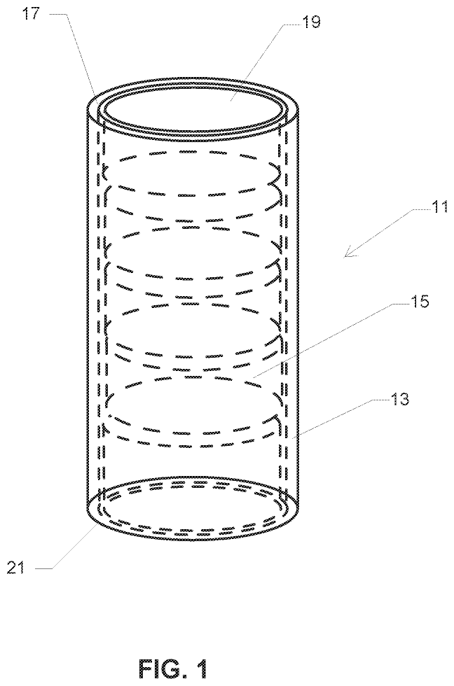

Shown in FIG. 1 is a reagent sleeve system 11 which includes a reagent sleeve 13 containing a series of reagent reservoirs 15 which are each individually sealed. In some embodiments, each of the reagent reservoirs 15 within a reagent sleeve 13 can have the same reagent or one or more of the reagent reservoirs 15 within a region sleeve 13 can have a combination of reagents or a different reagent or a different combination of reagents from one or more other reagent reservoirs 15 within a reagent sleeve 13. In some embodiments, the combination of reagents present in each of the reagent reservoirs 15 can be different from each of the other reagent reservoirs 15 within a reagent sleeve. In addition, in some embodiments all of the reagent reservoirs 15 within a reagent sleeve 13 can have the same expiration date set. In some embodiments, one or more of the reagent reservoirs 15 within a reagent sleeve 13 can have the same expiration date set as one or more of the reagent reservoirs 15 within a region sleeve. In some embodiments, all of the reagent reservoirs 15 within a region sleeve 13 can have a different expiration date set from each other.

As used herein, and expiration date set is the set of expiration dates for the reagent(s) present in a sample of reagent material, such as the contents of a reagent reservoir. Expiration dates can be provided for individual reagents and also for particular combinations of reagents. In addition, expiration dates can be tied to a particular analysis for which a reagent is being used, with the result that the same reagent can have different expiration dates for different analyses. Also, expiration dates can be linked to particular events, such as the date a reagent was made, a solution was made that comprises the reagent, the reagent reservoir was filled, the storage conditions of the reagent, a reagent reservoir is opened or other events.

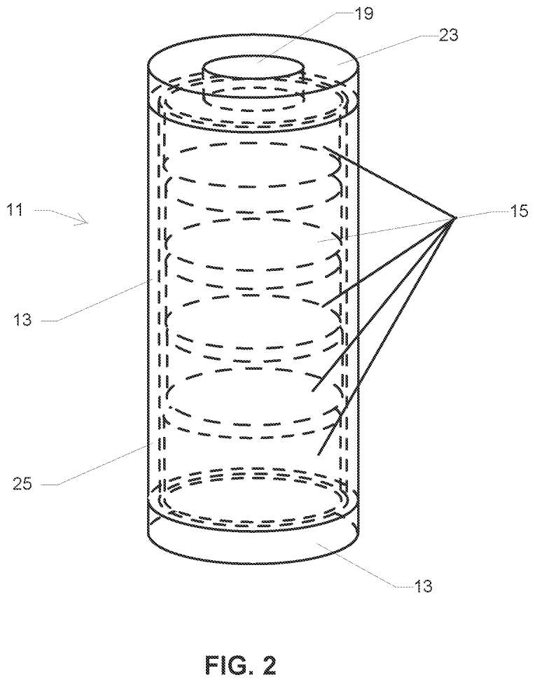

In some embodiments of a reagent sleeve system 11, a reagent sleeve 13 can have one or more open ends, such as a first end 17 that is open and/or a second end 21 that is open, such as that shown in FIG. 1. In some embodiments of a reagent sleeve system 11, a reagent sleeve 13 can have one or more ends that are covered such as a first end 17 having an end wall 23 and/or a second end 21 having an end wall 23, as shown in FIG. 2. In some embodiments, an end wall 23 can have an opening 19. The opening 19 can be any desired size. In some embodiments, an opening 19 can be provided for passage of a reagent extractor 41. In some embodiments, an opening 19 can be provided for inspection of the contents of the reagent sleeve 13. In some embodiments, an opening 19 can be provided for other reasons.

End wall 23 can be removable or permanent. In some embodiments, end wall 23 can be mechanically affixed to a peripheral wall 25 of the reagent sleeve 13 (or a material between the end wall 23 and the reagent sleeve 13), such as by threading, pinning, screws, rivets, etc. In some embodiments, and wall 23 can be affixed to a peripheral wall 25 of the reagent sleeve 13 (or a material between the end wall 23 and the reagent sleeve 13), such as by gluing, cementing, melting, welding, brazing, soldering, etc. in some embodiments, one or more of end wall 23 can be formed integrally with reagent sleeve 13 (or a material between the end wall 23 and the reagent sleeve 13), such as by molding, casting, etc.

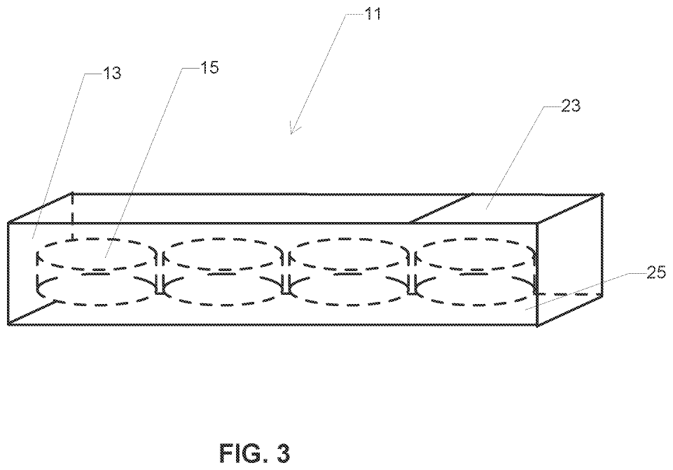

In some embodiments, a reagent sleeve system 11 can have round tubular shape, such as a cylinder such as that shown in FIGS. 1 and 2, and ovalized tubular shape, a square or rectangular tubular shape such as that shown in FIG. 3, or another shape that encloses all of or a substantial part of the set of reagent reservoirs 15 located within the reagent sleeve 13.

In some embodiments, a reagent sleeve system 11 can include an opening 27 in the wall of the reagent sleeve system 11, such as in the reagent sleeve 13. FIG. 3 shows an opening 27 in an upper side of rectangular region sleeve 13 that is located to correspond to one of the reagent reservoirs 15 present within the reagent sleeve 13. However, an opening 27 in the side of the reagent sleeve system can be located on another wall or combination of walls of a rectangular region sleeve 13, such as one or more of an upper wall, one or more sidewalls, and lower wall. In addition, an opening 27 on the side of the reagent sleeve system 11 can be present in region sleeve systems 11 having different shaped region sleeve 13, such as round tubular, such as cylindrical, ovalized tubular or other shapes. In some embodiments, an opening 27 can be located on the side of an end wall 23.

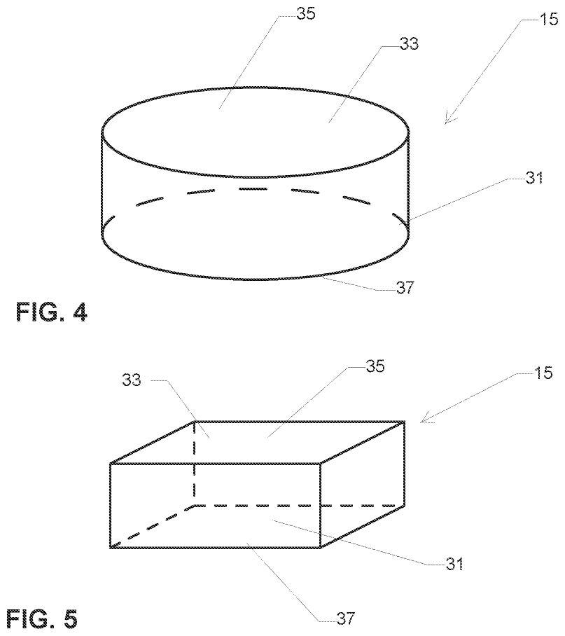

FIG. 4 shows a reagent reservoir 15 having a cylindrical peripheral wall 31 and flat first and second ends 33, 37. The first and second ends 33, 37 are closed to contain the reagent material located within the reagent reservoir 15. In some embodiments, the first and/or second end 33, 37 can be closed and can be pierceable, such as by a reagent extractor 43. In some embodiments, the first and/or second end 33, 37 can be or comprise a septum 35 that is pierceable, such as by a reagent extractor 43. In some embodiments, the septum 35 can be a film or a sheet. In some embodiments, a film or a sheet can be the entire closure or the entire end for the first and/or second end 33, 37. (“Film” can be viewed as a material that is up to 0.25 mm thick, and “sheet” can be viewed as material that is thicker.)

Suitable materials for the first and/or second end 33, 37 closure can include (in whole or in part) elastomeric and plastic materials, such as semi-transparent, transparent, opaque, or semi-opaque materials and can in some embodiments comprise or consist of flexible polyolefin films or sheets (for example polyethylene produced by polymerization of ethylene or polypropylene produced by polymerization of propylene), thermoplastic polyolefins such as polymethylpentene and polybutene and elastomeric polyolefins such as polyisobutylene or other material(s) with sufficient chemical compatibility with the reagent (including any solvent and/or carrier) and providing suitable structural strength, barrier characteristics (light, chemical including gas such as oxygen, microbial) and sealing characteristics. Suitable materials for the peripheral wall 31 of the reagent reservoir 15 can include (in whole or in part) elastomeric and plastic materials, such as semi-transparent, transparent, opaque, or semi-opaque materials and can in some embodiments comprise or consist of polyolefin materials such as polyethylene produced by polymerization of ethylene or polypropylene produced by polymerization of propylene, thermoplastic polyolefins such as polymethylpentene and polybutene and elastomeric polyolefins such as polyisobutylene or other material(s) with sufficient chemical compatibility with the reagent (including any solvent and/or carrier) and providing suitable structural strength, barrier characteristics (light, chemical including gas such as oxygen, microbial) and sealing characteristics. In some embodiments, the peripheral wall 31 can be a thicker material than the first and/or second end 33, 37 closure. In general, portions of the reagent reservoir 15 that are in contact with the reagent(s) can be suitable for containing the appropriate reagent(s) including any solvent present.

FIG. 5 shows a design of a reagent reservoir 15 having a different shape. In FIG. 5, a reagent reservoir 15 is shown with a rectangular cross-section to provide a “box” or “rectangular prism” shape, but other shapes can be utilized as well such as those with three, four, five, six or more sides.

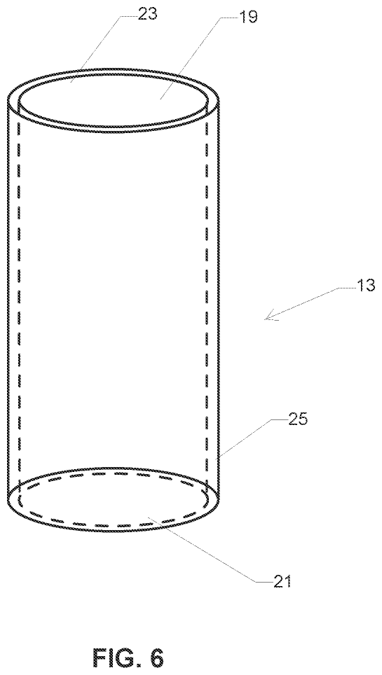

FIG. 6 shows a reagent sleeve 13 having a peripheral wall 25 and first end 23 and second end 21. The reagent sleeve in FIG. 6 is shown with a circular cross-section (cylindrical), but other shapes can be utilized as well such as those with a rectangular cross-section or those having three, four, five, six or more sides. In some embodiments, the cross-sectional shape of the reagent sleeve 13 can be the same or different from the cross-sectional shape of the reagent reservoir 15 being used therein.

Suitable materials for region sleeve 13 can include any rigid or semi rigid materials, such as plastics, metals, cardboard, elastomers, etc. which are able to hold the reagent reservoirs within.

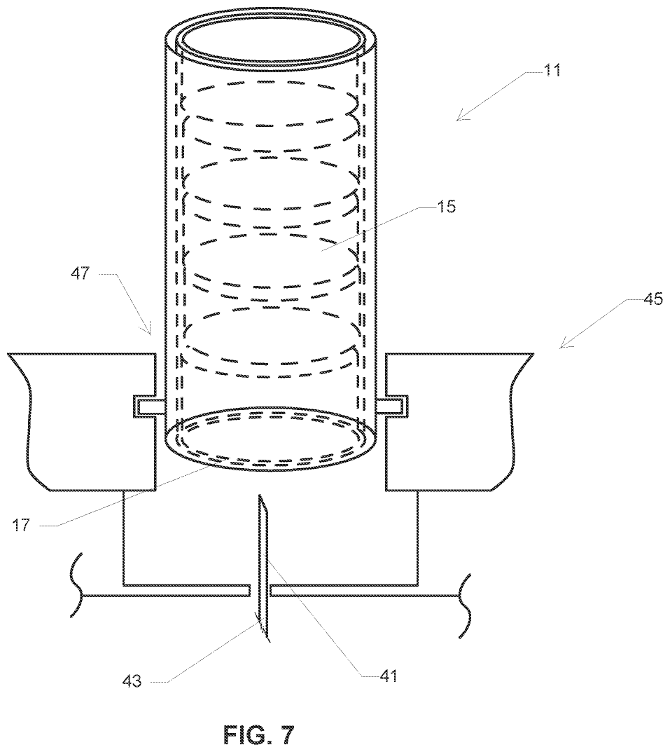

FIG. 7 shows an embodiment of a reagent sleeve system 11 interfaced with an analyzer 45. In this embodiment, the reagent sleeve system 11 is located with a first end located proximal a reagent extractor 41. The region sleeve system 11 is located within a reagent sleeve system port 47 of the analyzer 45. In this embodiment, the reagent sleeve system 11 is inserted into the reagent sleeve system port 47 with retainers holding the reagent sleeve system 11 in place. Retainers can be any suitable type such as a friction interface between the reagent sleeve system 11 and the reagent sleeve system port 47, threads, quarter-turn retention system (e.g. bayonet mount), Or bracket extending over the reagent sleeve system 11, or any other suitable feature for holding the reagent sleeve system 11 in place during operation of the analyzer 45.

Other configurations of interfacing a reagent sleeve system 11 with an analyzer 45 are possible including positioning the reagent sleeve system vertically, horizontally, or some angle therebetween.

In some embodiments, the reagent extractor 41 can enter the reagent reservoir 15 from below, from above, or from the side.

In some embodiments, the reagent extractor 41 can interface with a reagent reservoir 15 while the reagent reservoir 15 is within the region sleeve 13. In some embodiments, the reagent extractor 41 can interface with a reagent reservoir 15 that has been removed from the region sleeve 13. In some embodiments, the reagent extractor 41 can interface with successive reagent reservoirs 15 by passing through one reagent reservoir 15 and entering a second reagent reservoir 15, such as by piercing a first end 33 of a first reagent reservoir 15 to enter the first reagent reservoir 15, followed by piercing the second end 31 of the first reagent reservoir 15 and piercing the first end 33 of a second reagent reservoir 15 and entering the second reagent reservoir 15.

In another embodiment, the reagent extractor 41 can interface with successive reagent reservoirs 15 by interfacing with a first reagent reservoir 15, withdrawing the reagent extractor 41 from the first reagent reservoir 15 followed by movement or removal of the first reagent reservoir 15 and then interfacing the reagent extractor 41 with a second reagent reservoir 15. One such embodiment can include steps of piercing a first end 33 of the first reagent reservoir 15 to enter the first reagent reservoir 15, followed by withdrawing the reagent extractor 41 from the first reagent reservoir 15, optionally moving the first reagent reservoir 15, optionally moving a second reagent reservoir 15 to a position to interface with the reagent extractor 41 and then the reagent extractor 41 piercing the first end 33 of the second reagent reservoir 15.

A reagent extractor transports the reagent from within to without the reagent reservoir 15. In some embodiments, the reagent extractor 41 can be a needle or a tube. The reagent extractor 41 can have a conduit 43 running longitudinally through the body of the reagent extractor 41, such as a conduit 43 through a needle or tube. In some embodiments, an end of the reagent extractor 41 can be sharpened.

Various methods can be used to operate the reagent sleeve system 11. One embodiment of a method of operation includes an embodiment of a filling operation of the reagent sleeve system 11. An embodiment of a filling operation can include the steps of placing a plurality of reagent reservoirs into the reagent sleeve 13 of a reagent sleeve system 11 and optionally labeling the reagent sleeve system 11. In some embodiments, additional optional steps can include placing one or more end walls 23 onto reagent sleeve system 11. In some embodiments, one or more end walls 23 can be a film or sheet placed onto the end of the reagent sleeve system 11. In some embodiments, the reagent reservoir(s) 15 can be placed into the reagent sleeve 13 through an opening 19 in the first end 17 or second end 21 of the reagent sleeve system 11. In some embodiments, the reagent reservoir(s) 15 can be placed into the reagent sleeve 13 through an opening 27 on a side of the reagent sleeve system 11.

One embodiment of a method of operation includes using the reagent sleeve system 11 in an analyzer 45. An embodiment of a use in an analyzer can include steps of advancing a reagent extractor 41 to pierce a first end 33 of a reagent reservoir 15 with the reagent extractor 41 entering the reagent reservoir 15 and fluidly connecting the reagent reservoir with the analyzer 45 through the reagent extractor 41, withdrawing reagent from the reagent reservoir through the reagent extractor 41, such as by conducting reagent through a conduit 43 running through the reagent extractor 43. From the reagent extractor 43, the reagent can be conveyed to a point of use within the analyzer 45. The analyzer 45 can also perform additional steps, such as measuring, metering, heating, cooling, mixing, combining with other reagents, etc.

Another embodiment of a use in an analyzer can include steps of advancing a reagent reservoir 15 (while located within a reagent sleeve system 11 or not located within a reagent sleeve system 11) toward a reagent extractor 41, and optionally advancing a reagent extractor 41 toward a reagent reservoir 15, to pierce a first end 33 of a reagent reservoir 15 with the reagent extractor 41 entering the reagent reservoir 15 and fluidly connecting the reagent reservoir with the analyzer 45 through the reagent extractor 41, withdrawing reagent from the reagent reservoir through the reagent extractor 41, such as by conducting reagent through a conduit 43 running through the reagent extractor 43. From the reagent extractor 43, the reagent can be conveyed to a point of use within the analyzer 45. The analyzer 45 can also perform additional steps, such as measuring, metering, heating, cooling, mixing, combining with other reagents, etc.

An embodiment of a use in an analyzer can also include an embodiment of changing reagent reservoirs. One embodiment of changing a reagent reservoir 15 can include withdrawing reagent extractor 41 from a first reagent reservoir 15 by moving the first reagent reservoir 15 and or by moving the reagent extractor 41, positioning a second reagent reservoir 15 to be pierced by the reagent extractor 41 by one or more of the steps of moving the first reagent reservoir 15, moving the second reagent reservoir 15 and moving reagent extractor 41, piercing the first end 33 of the second reagent reservoir 15 with the reagent extractor 41 by moving one or more of the reagent extractor 41 and second reagent reservoir 15 toward one another, with the reagent extractor 41 entering the second reagent reservoir 15 and fluidly connecting the reagent reservoir with the analyzer 45 through the reagent extractor 41, withdrawing reagent from the reagent reservoir through the reagent extractor 41, such as by conducting reagent through a conduit 43 running through the reagent extractor 43. From the reagent extractor 43, the reagent can be conveyed to a point of use within the analyzer 45. The analyzer 45 can also perform additional steps, such as measuring, metering, heating, cooling, mixing, combining with other reagents, etc.

One embodiment of changing a reagent reservoir 15 can include piercing the second end 37 of the first reagent reservoir 15 with the reagent extractor 41 by moving the reagent extractor 41 and/or the first reagent reservoir 15 such that the reagent extractor 41 passes completely through the first reagent reservoir 15, piercing the first end 35 of a second reagent reservoir 15 by moving the reagent extractor 41 and/or the second reagent reservoir 15 toward one another, piercing the first end 33 of the second reagent reservoir 15 with the reagent extractor 41 by moving one or more of the reagent extractor 41 and second reagent reservoir 15 toward one another, with the reagent extractor 41 entering the second reagent reservoir 15 and fluidly connecting the reagent reservoir with the analyzer 45 through the reagent extractor 41, withdrawing reagent from the reagent reservoir through the reagent extractor 41, such as by conducting reagent through a conduit 43 running through the reagent extractor 43. From the reagent extractor 43, the reagent can be conveyed to a point of use within the analyzer 45. The analyzer 45 can also perform additional steps, such as measuring, metering, heating, cooling, mixing, combining with other reagents, etc.

In various embodiments, these different operational methods can be combined as desired.

As used herein, the words “approximately”, “about”, “substantially”, “near” and other similar words and phrasings are to be understood by a person of skill in the art as allowing for an amount of variation not substantially affecting the working of the device, example or embodiment. In those situations where further guidance is necessary, the degree of variation should be understood as being 10% or less. Use of the word “or” or related words is intended to be inclusive and is equivalent to the expression “and/or,” unless the context clearly dictates otherwise. As such, for example, the expression “A or B” means A, or B, or both A and B. Similarly, for example, the expression “A, B, or C” means A, or B, or C, or any combination thereof.

Having now described the invention in accordance with the requirements of the patent statutes, those skilled in this art will understand how to make changes and modifications to the present invention to meet their specific requirements or conditions. Such changes and modifications may be made without departing from the scope and spirit of the invention as disclosed herein.

The foregoing Detailed Description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Use of the word “or” should be understood to also include the meaning “and”, except where the context indicates otherwise. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the Claims.

What is claimed is:

1. A reagent sleeve system comprising:
a reagent sleeve; and
a plurality of removable reagent reservoirs located within the reagent sleeve,
wherein
each of the plurality of removable reagent reservoirs comprises a respective peripheral wall, and first and second end walls, whereby each of the plurality of removable reagent reservoirs contains a reagent located therein, and the first end wall is pierceable by a reagent extractor, and
the reagent sleeve comprises a peripheral wall that encompasses the plurality of removable reagent reservoirs and holds the plurality of reagent reservoirs for sequential use.

2. The reagent sleeve system of claim 1, wherein the second end wall of each of the plurality of removable reagent reservoirs is pierceable by a reagent extractor.

3. The reagent sleeve system of claim 1, wherein the plurality of reagent reservoirs is arranged end-to-end.

4. The reagent sleeve system of claim 2, wherein the plurality of reagent reservoirs is arranged end-to-end and the reagent extractor can pass from pass through a first of the plurality of reagent reservoirs and into a second of the plurality of reagent reservoirs.

5. The reagent sleeve system of claim 1, wherein the peripheral wall each of the plurality of reagent reservoirs is cylindrical.

6. The reagent sleeve system of claim 1 wherein the first end wall of each of the plurality of reagent reservoirs comprises a pierceable film.

7. The reagent sleeve system of claim 1, wherein the reagent sleeve comprises a first opening through which each of the plurality of reagent reservoirs can pass.

8. The reagent sleeve system of claim 1, wherein the reagent sleeve comprises a second opening aligned with the pierceable first end wall of a first of the plurality of reagent reservoirs, wherein the reagent extractor passes through the second opening when the reagent extractor pierces the pierceable first end wall of the first reagent reservoir.

9. The reagent sleeve system of claim 8, wherein the second opening is covered with a pierceable cover.

10. The reagent sleeve system of claim 1, wherein the reagent sleeve is sized and configured to interface with an analyzer, chemical analyzer or clinical analyzer and the reagent extractor to pierce the first end wall of one of the plurality of reagent reservoirs.

11. The reagent sleeve system of claim 1, wherein each of the plurality of reagent reservoirs comprises a set of analysis reagents, with each of the set of analysis reagents having an expiration date set, and each of the plurality of reagent reservoirs has the same set of analysis reagents with the same expiration date sets.

12. An analyzer, chemical analyzer or clinical analyzer comprising:
a reagent sleeve system port configured to receive the reagent sleeve system of claim 1;
the reagent sleeve system removably connected to the reagent sleeve port;
the reagent extractor configured to deliver reagent from one of the plurality of reagent reservoirs for use in the analyzer, chemical analyzer or clinical analyzer.

13. A method of using the analyzer, chemical analyzer or clinical analyzer of claim 12, the method comprising:
piercing the first end wall of one of the plurality of reagent reservoirs with the reagent extractor of the analyzer, chemical analyzer or clinical analyzer of claim 12 to fluidly connect the one of the plurality of reagent reservoirs with the analyzer, chemical analyzer or clinical analyzer through the reagent extractor; and
withdrawing reagent from the one of the plurality of reagent reservoirs through the reagent extractor.

14. The method of claim 13, further comprising:
removing the one of the plurality of reagent reservoirs from the reagent sleeve prior to piercing the first end wall of the one of the plurality of reagent reservoirs with the reagent extractor.

15. The method of claim 13, wherein the one of the plurality of reagent reservoirs is located at least partially within the reagent sleeve when the reagent is withdrawn from the one of the plurality of reagent reservoirs through the reagent extractor.

16. The method of claim 13, further comprising:
withdrawing the reagent extractor from the one of the plurality of reagent reservoirs;
then moving a second of the plurality of reagent reservoirs to a position where the first end wall of the second of the plurality of reagent reservoirs is pierceable by the reagent extractor;
then piercing the first end wall of the second of the plurality of reagent reservoirs with the reagent extractor to fluidly connect the second of the plurality of reagent reservoirs with the analyzer, chemical analyzer or clinical analyzer through the reagent extractor; and
withdrawing reagent from the second of the plurality of reagent reservoirs through the reagent extractor.

17. The method of claim 13, further comprising:
moving the reagent extractor through the second end wall of the one of the plurality of removable reagent reservoirs;
piercing the first end wall of the second of the plurality of reagent reservoirs with the reagent extractor;
fluidly connecting the second of the plurality of reagent reservoirs with the analyzer, chemical analyzer or clinical analyzer through the reagent extractor; and
withdrawing reagent from the second of the plurality of reagent reservoirs through the reagent extractor,
wherein the second end wall the one of the plurality of removable reagent reservoirs is pierceable by a reagent extractor.

18. The analyzer, chemical analyzer or clinical of claim 12, wherein the analyzer, chemical analyzer or clinical is a chemical analyzer.

19. The analyzer, chemical analyzer or clinical of claim 12, wherein the analyzer, chemical analyzer or clinical is a clinical analyzer.
